(19) United States
(12) Patent Application Publication
(10) Pub. No.: US 2019/0176253 A1
(43) Pub. Date: Jun. 13, 2019

(54) METHOD FOR GEAR CUTTING A WORKPIECE

(71) Applicant: Liebherr-Verzahntechnik GmbH, Kempten (DE)

(72) Inventor: Oliver WINKEL, Kempten (DE)

(21) Appl. No.: 16/216,472

(22) Filed: Dec. 11, 2018

(30) Foreign Application Priority Data
Dec. 12, 2017 (DE) 10 2017 129 651.4

(51) Int. Cl. B23F 9/08

(52) U.S. Cl. CPC B23F 9/08

(57) ABSTRACT

The present disclosure shows a method for gear cutting a workpiece on a machine tool that comprises a workpiece holder drivable about an axis of rotation and at least one tool holder drivable about an axis of rotation, wherein for the gear cutting operation a tool with a circular cylindrical shell surface is used, which with its shell surface is guided along a tooth flank of the workpiece tangentially to the target contour to be produced. According to an embodiment of the present disclosure it is provided that the tangential alignment of the shell surface relative to the target contour to be produced is achieved by positioning the tool along a first linear axis and by a rotary position of the workpiece about its axis of rotation.

### CROSS REFERENCE TO RELATED APPLICATION

This application claims priority to German Patent Application No. 10 2017 129 651.4 filed Dec. 12, 2017, entitled “Method for Gear Cutting a Workpiece” the entire contents of which is hereby incorporated by reference in its entirety for all purposes.

### TECHNICAL FIELD

The present disclosure relates to a method for gear cutting a workpiece on a machine tool that comprises a workpiece holder drivable about an axis of rotation and at least one tool holder drivable about an axis of rotation. In the method, a tool with a circular cylindrical shell surface is used for gear cutting the workpiece, which with its shell surface is guided along the tooth flank of the workpiece tangentially to the target contour to be produced. The tool in particular can be an end mill.

### BACKGROUND AND SUMMARY

Such a method is known from EP 2314404 A1. In this document, the tool holder is pivoted via a pivot axis such that the tool rests against the tooth flank of the workpiece tangentially to the target contour to be produced, wherein in addition the angle of the tool relative to the height direction of the toothing and the direction of the feed movement are chosen such that the resulting machining marks correspond to virtual knife marks as they would be formed by a knife head when producing the corresponding tooth flank by means of gear hobbing, i.e. extend obliquely over the tooth flank.

From WO 2008/133517 A1 there is also known a method for gear cutting a workpiece by means of an end mill, wherein however among other things an end mill with a non-circular cylindrical shell surface is used, which corresponds to the target contour of the tooth flank of the workpiece in order to be able to thereby produce the entire tooth flank in only one machining stroke. However, this involves the disadvantage that a tool each specifically adapted to the toothing to be produced is required. WO 2008/133517 A1 also shows the use of other end mills with a spherical head or a circular cylindrical shell surface. The alignment of the end mill relative to the tooth flank is effected via the axes of a 5-axes machining center.

From WO 2012/052367 A1 a method for producing toothings on a 5-axes machining center is known, in which however a disk-shaped milling cutter is used.

From DE 10 2013 003 964 A1 a gear cutting machine with a dual machining head furthermore is known. Two machining heads are arranged on a linear guideway and might be linearly traversed on the same independent of each other, wherein the machining heads comprise motor spindles for accommodating machining tools. As tools, end mills can be used. During the machining process, the motor spindles can be arranged parallel or at an angle to each other, wherein the corresponding tools are in engagement with two different tooth flanks.

Tools with a circular cylindrical shell surface, and in particular end mills, are used where other tools cannot be used e.g. for reasons of collision, or in the prototype or small batch production. The use of an end mill has the advantage that in principle any desired flank shape and any desired toothing can be produced by means of an end mill, i.e. other than in most other gear cutting methods no tool adapted to the specific toothing is required.

According to conventional cutting, 5-axes machining centers as they are also known from the general milling operation usually are employed with such an end mill for milling toothings. In such 5-axes machining centers the machining strategy usually consists in moving the milling cutter, as far as possible, such that it remains in the vicinity of the center of the machining space. The background to this strategy is the fact that in usual machining centers the error tolerances with regard to the positioning of the milling cutter proceeding from the center of the working space become greater and greater. One embodiment provide for a particularly precise work it therefore is attempted to possibly always keep the milling cutter in the center of the working space, where the tolerances are small. To tangentially guide the end mill along the contour of the tooth flank to be produced, the end mill usually is brought into a corresponding pivot position. With regard to the precision in the production of the toothing, however, this strategy involves certain problems which the inventors of the present disclosure have recognized.

In a first aspect, it is the object of the present disclosure to provide an improved method for gear cutting by means of a tool with a cylindrical shell surface. The disclosed method increases the precision in the production of a desired target contour.

In a first aspect, the present disclosure comprises a method for gear cutting a workpiece on a machine tool that comprises a workpiece holder drivable about an axis of rotation and at least one tool holder drivable about an axis of rotation, wherein for the gear cutting operation a tool with a circular cylindrical shell surface is used, which with its shell surface is guided along a tooth flank of the workpiece tangentially to the target contour to be produced. According to an embodiment of the present disclosure it is provided that the tangential alignment of the shell surface relative to the target contour to be produced is achieved by positioning the tool along a first linear axis and by a rotary position of the workpiece about its axis of rotation.

Other than in the gear cutting operation by means of end mills in conventional 5-axes machining centers, pivoting of the tool for a tangential alignment relative to the target contour therefore may be is omitted. Instead, the tangential alignment of the tool with the target contour to be produced is generated by a superposition of the rotary movement of the workpiece with a lateral translational movement of the tool.

In one embodiment, the tool is operated with an alignment by which the axis of rotation of the tool extends parallel to the direction of thermal expansion of the machine tool. This has the advantage that other than in known methods, in which the tool is pivoted, a thermal expansion of the machine has no direct influences on the contour produced. A thermal expansion rather only leads to a displacement of the tool parallel to its axis of rotation and hence parallel to the line of engagement with the toothing to be produced, and therefore has no influence on the contour produced.

In another embodiment, the tool can be an end mill. Such an end mill can be used for rough machining the workpiece and/or for finish machining the workpiece. Alternatively, the tool can also be an abrasive pencil.

In yet another embodiment, the tool for machining a tooth flank of the workpiece is guided along the tooth flank in at least one machining stroke in the workpiece width direction. This can be effected by traversing the tool relative to the workpiece along a third linear axis and/or via a third linear axis that extends parallel to the axis of rotation of the workpiece.

In a further embodiment, the machining of the tooth profile is effected in several machining strokes offset from each other in the height direction of the tooth flank, wherein the offset of the machining strokes from each other is achieved by a correspondingly changed position of the tool along the first linear axis and a correspondingly changed angle of rotation of the workpiece about its axis of rotation. Between two machining strokes the workpiece therefore is rotated by a defined angle and the tool is shifted by a defined distance along the first linear axis so that the region of engagement between the tool and the tooth flank is shifted in the height direction and the alignment of the tool is adapted to the course of the target contour at the new height position.

According to the present disclosure, the alignment of the tool possibly remains unchanged during the gear cutting operation and/or for several and possibly all machining strokes.

Furthermore, the tool can be aligned parallel to a direction of thermal expansion of the machine tool. As already described above, it thereby is avoided that a thermal expansion of the machine tool has a negative influence on the toothing quality. According to the present disclosure, the term direction of thermal expansion of the machine tool designates the main direction of a thermal expansion between the workpiece holder and the tool holder.

In a possible embodiment of the present disclosure the tool always is aligned parallel to a second linear axis (X1) that extends radially to the workpiece center at least during finishing and/or the final machining of the workpiece.

In a possible embodiment of the present disclosure the axis of rotation of the workpiece is perpendicular to the first linear axis and/or perpendicular to a third linear axis that extends parallel to the axis of rotation of the workpiece.

When it is stated in the context of the present disclosure that a particular direction is perpendicular to another direction, this means that the particular direction extends in a plane that is perpendicular to the other direction, or vice versa, unless otherwise indicated.

According to an embodiment of the present disclosure, a traversing movement of the tool along the first linear axis and a rotary movement of the workpiece about its axis of rotation to produce a tooth flank of an involute toothing possibly are in a linear relationship to each other. This linear relationship can apply for a plurality of traversing movements and rotary movements taking place between two machining strokes.

According to an embodiment of the present disclosure, the traversing movement of the tool along the first linear axis possibly corresponds to the roll-out of the base circle of the involute toothing. When the workpiece therefore is rotated by a certain angle of rotation, the tool possibly is moved by the corresponding roll-out of the base circle along the first linear axis.

The traversing movement of the tool and the rotary movement of the workpiece may be chosen such that proceeding from a position in which an extension of the line of engagement of the shell surface of the tool with the workpiece intersects the axis of rotation of the workpiece a linear relationship between traversing movement and rotary movement is obtained and/or the traversing movement of the tool along the first linear axis corresponds to the roll-out of the base circle of the involute toothing for the rotary movement of the workpiece.

In an embodiment when the involute of the target contour to be produced reaches up to the base circle, the tool producing the toothing in the region of the base circle of the involute toothing possibly is arranged such that an extension of the line of engagement of the shell surface of the tool with the workpiece intersects the axis of rotation of the workpiece.

Furthermore, for the production of the tooth flank of an involute toothing the position of the tool along the first linear axis and the rotary position of the workpiece can be chosen such that in each end section plane a line that extends through the point of contact of the shell surface of the tool with the target contour to be produced tangentially to a base circle of the toothing of the workpiece extends parallel to the first linear axis.

The conditions indicated above may be applied exactly for unmodified toothings, but only approximately for modified toothings. In an embodiment when a modified involute toothing is to be produced, a modification with respect to an exactly linear relationship or with respect to the traversing movement specified exactly by the roll-out of the base circle possibly is made in order to produce profile modifications. In particular, the respective traversing and rotary movement between two first machining strokes and two second machining strokes can be superimposed with modifications as compared to the movements provided for an unmodified involute toothing.

In a possible embodiment of the present disclosure the axis of rotation of the tool extends in a plane that is perpendicular to the axis of rotation of the workpiece. Alternatively or in addition, the first linear axis can extend in a plane that likewise is perpendicular to the axis of rotation of the workpiece. Furthermore alternatively or in addition, the axis of rotation of the tool can be perpendicular to the first linear axis. This embodiment may provide particularly favorable conditions with regard to the kinematic configuration of the machine tool.

The method according to an embodiment of the present disclosure possibly is used for producing and/or machining large toothings. A large toothing may be referred to as a toothing diameter greater than 500 mm and/or a modulus greater than 8.

In a possible embodiment of the present disclosure the tool holder is traversable perpendicularly to the axis of rotation of the workpiece holder via a second linear axis, wherein the first and the second linear axis are perpendicular to each other and/or wherein the axis of rotation of the tool holder is aligned parallel to the second linear axis at least during the gear cutting operation. Due to the traversability along the second linear axis, the position of the tool can be shifted in a direction tangential to its shell surface and hence tangential to the target contour. The shifted position allows for adapting the position of the tool holder to the size of the gear wheel and possibly for traversing the tool into the tooth gap.

During the gear cutting operation, the position of the tool holder possibly can also be changed along the second linear axis, in particular in order to arrange and/or maintain the area of engagement between the shell surface of the tool and the tooth flank in a particular area of the shell surface.

Possibly, the position of the tool can be changed along the second linear axis between two machining strokes, in particular in order to ensure that the shell surface of the tool remains in engagement with the tooth flank. The position of the tool along the second linear axis, however, has no direct influence on the produced contour of the flank.

In a possible embodiment of the present disclosure the tool holder is traversable along a third linear axis parallel to the axis of rotation of the workpiece holder. Possibly, in the embodiment, the tool is guided along the tooth flank via the third linear axis in at least one machining stroke in the workpiece width direction. To produce a helical toothing, the traversal of the tool along the third linear axis possibly is superimposed with a rotary movement of the workpiece.

A separate gear cutting operation of the individual tooth flanks of the workpiece each may be effected, and in particular also a separate machining operation of the left tooth flanks and the right tooth flanks of the teeth of the workpiece.

In one embodiment of the present disclosure a tool for machining the left tooth flank of the workpiece is arranged along the first linear axis in a first area of linear positions, and a tool for machining the right tooth flank of the workpiece is arranged along the first linear axis in a second area of linear positions. In particular, the linear positions in the first and the second area each can serve the tangential alignment of the tool with the target contour at different machining strokes that are used for producing the tooth flank. As linear position of the tool, the position of the axis of rotation of the tool along the first linear axis each is regarded.

In an embodiment to produce a symmetrical toothing, the first and the second area possibly are arranged symmetrically with respect to a plane that extends radially to the axis of rotation of the workpiece and is aligned parallel to the axis of rotation of the tool and/or is perpendicular to the first linear axis.

In another embodiment, independent of the shape of the toothing, the first and the second area possibly overlap by a maximum of 50% of their expansion. Alternatively or in addition, the first and the second area possibly overlap by a maximum of twice the radius of the cylindrical shell surface of the tool, i.e. by twice the distance between the axis of rotation of the tool and its shell surface.

In a possible embodiment, the first and the second area cannot overlap at all. This is the case in particular when the tooth flank does not reach up to the base circle of the toothing. On the other hand, when the tooth flank reaches up to the base circle, the first and the second area possibly overlap by twice the radius of the cylindrical shell surface of the tool.

In a possible embodiment, the larger part of the two areas each lies on opposite sides of a plane that extends radially to the axis of rotation of the workpiece and is aligned parallel to the axis of rotation of the tool and/or is perpendicular to the first linear axis.

In the context of the present disclosure it is to be taken into account that for the production of larger gear wheels a relatively long traversability of the tool holder along the first linear axis is required. For the production of a left tooth flank, the tool is shifted to the left from a middle position, in which it is in engagement with the lower edge of the left tooth flank, along the first linear axis, while the workpiece is rotated in anti-clockwise direction until it is in engagement with the upper edge of the tooth flank. For machining the right flank, the tool gets in engagement with the toothing with the opposite side of its shell surface and correspondingly is traversed to the right from a middle position, while the workpiece is rotated in clockwise direction. Of course, each traversal in the reverse direction, coupled with a rotary movement into the reverse direction, also is possible. The larger the toothing, the larger traversing paths therefore are used along the first linear axis. The machine tool therefore requires a correspondingly long machine axis for traversing the tool holder along the first linear axis.

For machining a tooth flank it is not necessary that all machining strokes directly follow each other in the height direction. Rather, the individual machining strokes also can be effected in a mixed manner, as far as their arrangement in the height direction is concerned.

For example, it is conceivable to initially carry out a first machining stroke with a first arrangement lower in the height direction and then to carry out a machining stroke with a second arrangement higher in the height direction, or vice versa, and thereupon carry out a third stroke with an arrangement disposed between the first and the second arrangement in the height direction.

In a possible embodiment the same tool can be used for machining the left and the right tooth flank of the workpiece. After machining the one flank, the tool holder therefor may be traversed away from this flank along the first linear axis until the tool comes into engagement with the other tooth flank of the workpiece. The rotary movement of the workpiece is effected such that the tool again tangentially comes into engagement with the other tooth flank.

According to another embodiment of the present disclosure two tools are provided for machining the left and the right tooth flank of the workpiece, which each are accommodated in a tool holder. In particular, a first tool therefore can be used for machining a left tooth flank and a second tool can be used for machining a right tooth flank. Possibly, the two tools are tools with a circular cylindrical shell surface. For example, two identical tools can be used.

In a possible embodiment, the axes of rotation of the two tool holders are arranged parallel to each other. This can be ensured either by the construction of the machine tool or by a correspondingly parallel alignment of the tool holders, in case the same are pivotable.

In a possible embodiment, the machining of a left and a right tooth flank is effected at the same time. In particular, the one tool therefore can be used for machining a left tooth flank while at the same time the other tool is used for machining a right tooth flank. Possibly, these are the left and right tooth flanks of two different teeth of the workpiece.

In another possible embodiment, a plurality of machining strokes offset in the height direction of the respective tooth flank each are used in the machining operation. In particular, this can be effected in a way as has already been described above in detail.

In another possible embodiment, it is provided that successive machining strokes on the respective tooth flanks in the height direction are offset from each other in the reverse direction. When a first machining stroke on the one tooth flank therefore lies at a lower level than a second machining stroke, the corresponding first machining stroke on the other tooth flank possibly lies at a higher level than the corresponding second machining stroke. The offset therefore is effected in opposite directions on the two tooth flanks.

Furthermore, it can be provided that between two machining strokes the two tools are traversed along the first linear axis in the same direction and/or by the same distance. The traversing movement of the two tools between two machining strokes therefore possibly is effected in the same direction, and in particular such that the distance between the two tools remains constant.

The respective machining of the two flanks each can be effected such as this has already been set forth above in detail for the machining of one flank.

The present disclosure can be used both for the rough gear cutting and for the finish gear cutting of a workpiece.

Furthermore, the present disclosure can be used both for the soft machining of the workpiece and for the hard fine machining of a workpiece. The present disclosure may be used for the soft machining of a workpiece, i.e. for machining an unhardened workpiece when an end mill is used as a tool.

When the method according to the present disclosure is used for finish machining, i.e. for producing a workpiece surface of high quality, machining of the workpiece flank possibly is effected in a plurality of strokes.

For a rough gear cutting operation preceding the finish machining, i.e. for producing a rough contour of the toothing, it on the other hand is not necessary to use a method as it has been described above.

Rather, it is also possible for example to use a method conventional machines. A conventional milling cutter may be guided along the tooth gap to be produced in a plurality of tracks arranged one beside the other, wherein the desired tooth flank is approached incrementally.

Such a roughing method, however, is expensive and leads to a non-uniform wear of the tool, as the tool comes into engagement with the material of the workpiece chiefly with its head region.

A further object of the present disclosure consists in providing an improved method for the rough gear cutting of a workpiece.

In its second aspect, the present disclosure comprises a method for rough gear cutting a workpiece on a machine tool that includes a workpiece holder drivable about its axis of rotation and a tool holder drivable about its axis of rotation, and wherein for gear cutting a tool with a circular cylindrical or conical shell surface is used. According to the second aspect of the present disclosure it is provided that for producing a tooth pitch in at least one first machining stroke a groove is produced, which is aligned radially, and in at least two further machining strokes the shell surface of the tool each is aligned substantially tangentially to the target contour of the left and right flanks of the toothing forming the tooth pitch.

The radial groove possibly has a depth of at least 0.3 times the tool diameter. With the substantially tangential alignment of the tool the inclination possibly lies in the order of magnitude of the pressure angle of the toothing. Possibly, the axis of rotation includes an angle of less than 10°, further possibly less than 5° with respect to a tangential alignment and/or to the pressure angle of the toothing. Furthermore, the tool can be aligned tangentially to the target contour.

The method according to the present disclosure has the advantage that in the further machining strokes the tool comes into contact with the material of the workpiece to be removed chiefly with its shell surface so that a uniform loading of the tool takes place. Furthermore, the method has the advantage that a considerably better approach to the target contour of the toothing is achieved, and in particular the stepped design according to conventional methods.

The roughing method according to the present disclosure possibly is used to produce a toothing on a workpiece blank. In particular, the workpiece blank can be an untoothed blank.

Alternatively or in addition, the rough gear cutting operation can be carried out as a soft machining operation, i.e. on an unhardened workpiece.

What is possibly used as a tool is an end mill with a circular cylindrical or conical shell surface.

The tool can have a rounded head shape. Alternatively or in addition, the head of the tool can be used for machining the tooth base.

When a tool with a circular cylindrical shell surface is used, the tangential alignment of the shell surface of the tool possibly is effected in that the axis of rotation of the tool is aligned in parallel relative to the target contour of the tooth flank. When a tool with a conical shell surface is used, the tangential arrangement of the shell surface relative to the target contour is effected in that the axis of rotation is shifted relative to a tangent to the target contour by the cone angle.

When a tool with a conical shell surface is used, the cone angle possibly is chosen such that with a radial alignment of its axis of rotation and when machining the tooth base, the tool does not come into contact with the target contour of the tooth flanks.

According to an embodiment of the present disclosure it is conceivable that for each flank only one machining stroke is effected with a shell surface of the tool aligned tangentially relative to the target contour in order to machine the entire tooth flank. In particular in the case of very large toothings, deviations between an involute and a straight line often are relatively small so that this already provides for a sufficient approach to the target contour.

In an alternative embodiment of the present disclosure the machining of the tooth flanks can, however, also be effected in a plurality of machining strokes offset from each other in the height direction, in which the shell surface of the tool each is aligned tangentially to the target contour. This also each involves a corresponding change of the alignment of the tool relative to the workpiece.

Possibly, machining the tooth flank however is effected in less than ten strokes, more possibly in less than five strokes, more possibly in less than three strokes.

The tool possibly is relatively broad. Possibly, the diameter of the circular cylindrical shell surface is at least 30% of the smallest distance between the tooth flanks, more possibly at least 40%, more possibly at least 60% and more possibly at least 75% of this distance. The smallest distance between the tooth flanks is defined by the distance of the points of the tooth flank nearest to the tooth base.

In the context of the entire present disclosure the tooth flank is understood to be the active part of the toothing on a flank of a tooth, which usually has the shape of an involute or an involute with modifications. In the context of the present disclosure, the non-involute region of the tooth base or the tooth head is not referred to as tooth flank.

When a tool with a conical shell surface is used, the above-mentioned dimensions for the diameter of the circular cylindrical shell surface possibly apply for the broadest and more possibly for the narrowest part of the shell surface, i.e. the largest diameter of the shell surface or the smallest diameter of the conical region of the shell surface, i.e. before the conical shell surface possibly ends in a rounding at the tip.

According to a possible embodiment of the second aspect, at least two differently large tools can be used one after the other in order to produce a first radial groove of larger width and in this groove a second radial groove of smaller width. In particular, at least two tools of differently large diameter can be used.

Possibly, the smaller or smallest tool or the tool having the smaller or smallest diameter is used for producing the tooth base.

Alternatively or in addition, the smaller or smallest tool or the tool having the smaller or smallest diameter can also be used for the two further machining strokes with a shell surface aligned tangentially to the target contour.

By producing a larger groove and a smaller groove, the material remaining on the tooth flank in the upper region after producing the radial groove or grooves, which is then removed by the tangential machining strokes, is reduced.

Possibly, however, only one machining stroke each is effected at the same tooth height in the context of the present disclosure, i.e. there is no longer used a plurality of machining strokes arranged one beside the other at the same tooth height.

The method according to the second aspect of the present disclosure initially is independent of the method according to the first aspect. In particular, the alignment of the tool relative to the workpiece can be effected by pivoting the workpiece holder and/or without a rotation of the workpiece. In the context of the second aspect this is less critical in so far as in rough gear cutting less strict requirements exist concerning the tolerances to be observed.

Possibly, however, the second aspect of the present disclosure is combined with the first aspect of the present disclosure. In this case, the change in the alignment of the tool is effected between the radial stroke and the two strokes with a tangential alignment by linearly traversing the tool along the first linear axis and by a rotary movement of the workpiece. In particular, this can be effected as has already been set forth above in detail.

Beside the method according to the present disclosure, the present disclosure furthermore comprises a corresponding machine tool.

An embodiment of the present disclosure comprises a machine tool with a workpiece holder drivable about an axis of rotation and at least one tool holder drivable about an axis of rotation and with a control unit for carrying out at least one of the methods described above in detail. In particular, the control unit is configured such that the machine tool automatically carries out a method as it has been described above in detail.

The control unit according to the present disclosure therefor can include corresponding control functions and/or a corresponding programming by which a method according to the present disclosure is worked off automatically.

The control unit possibly comprises a microcontroller, a non-volatile memory in which a control program is stored, and control lines for actuating the axes of rotation of the machine tool as well as machine axes of the machine tool.

The machine axes of the machine tool possibly are NC axes.

According to a possible embodiment of the present disclosure, the tool holder can be non-rotatably arranged on the machine tool and be traversable via one or more linear axes. Such a machine tool in particular can be used for carrying out a method according to the first aspect. Possibly, the machine tool includes three linear axes perpendicular to each other. In particular, those linear axes can be provided that have already been described above in detail in the context of the present disclosure.

The tool holder can, however, also be rotatably arranged on the machine tool, and for carrying out the first aspect in this case possibly is held or arrested in a swivel position in order to carry out the method according to the present disclosure.

In a possible embodiment of the present disclosure the tool holder is arranged on a machining head that is disposed opposite the workpiece holder in a second linear axis that is perpendicular to the first linear axis and/or extends parallel to the axis of rotation of the tool holder.

Via a machine stand, the machining head in particular can be arranged on a machine table that carries the workpiece holder, wherein the machine table extends between the workpiece holder and the machining head along the second linear axis. In such a construction, the second linear axis corresponds to the direction of thermal expansion of the machine tool. As described above, the axis of rotation of the tool holder therefore possibly is aligned parallel to the second linear axis.

In a first exemplary embodiment of the machine tool according to the present disclosure the same includes a tool holder which from a first side of a plane that extends radially to the axis of rotation of the workpiece holder and is aligned parallel to the axis of rotation of the tool holder and/or perpendicularly to the first linear axis is traversable to the opposite side.

Alternatively or in addition, the traversing path provided by the first machine axis can be symmetrical to a plane that extends radially to the axis of rotation of the workpiece holder and is aligned parallel to the axis of rotation of the tool holder and/or perpendicular to the first linear axis.

An embodiment of the machine tool according to the present disclosure can have only one tool holder, which in this case possibly is used both for machining a left tooth flank and for machining a right tooth flank.

In an alternative embodiment of the present disclosure the machine tool comprises at least two tool holders each drivable about an axis of rotation, which are separately traversable along the first linear axis. In particular, the two tool holders can be used to machine a left and a right flank of the workpiece at the same time, as this has been described above in detail.

Possibly, the two tool holders are traversable along the first linear axis on a common guide of the machine tool. Alternatively or in addition, the two tool holders can be traversable via one or more common linear axes. In particular, the two tool holders can be arranged on a machining head that is traversable via at least two linear axes.

The present disclosure will now be described in detail with reference to drawings and exemplary embodiments.

### BRIEF DESCRIPTION OF THE FIGURES

FIG. 1 shows an exemplary embodiment of a machine tool according to the present disclosure in a schematic diagram.

FIG. 2 shows a first exemplary embodiment of a method of the present disclosure according to the first aspect of the present disclosure in a schematic diagram.

FIG. 3 shows a second exemplary embodiment of a method of the present disclosure according to the first aspect of the present disclosure in a schematic diagram.

FIG. 4 shows a detail view of a machining head of a first exemplary embodiment of a machine tool according to the present disclosure, which in particular can be used for carrying out a method according to FIG. 2.

FIG. 5 shows a second exemplary embodiment of a machining head of a machine tool according to the present disclosure, which in particular can be used for carrying out a method according to FIG. 3.

FIG. 6 shows a rough gear cutting method according to conventional methods and machines, which possibly can precede a method of the present disclosure according to the first aspect.

FIG. 7 shows an exemplary embodiment of an inventive rough gear cutting method according to the second aspect of the present disclosure in a schematic diagram.

FIG. 8 shows a combination of the inventive rough gear cutting method according to the second aspect of the present disclosure with the first aspect of the present disclosure.

### DETAILED DESCRIPTION

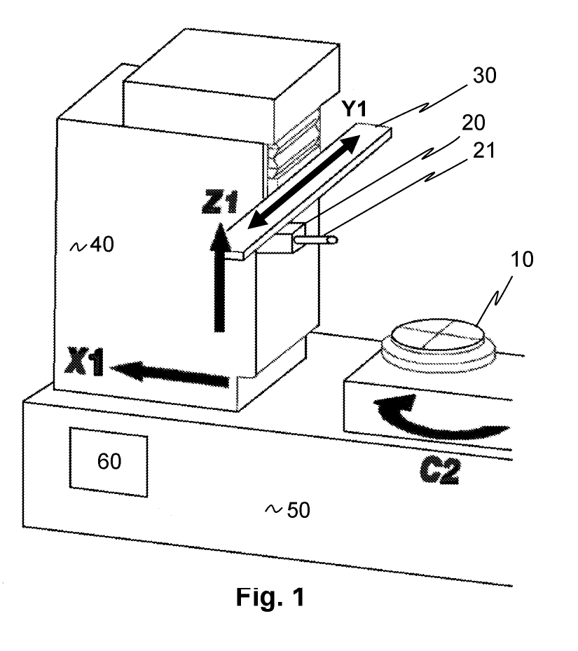

FIG. 1 shows a possible exemplary embodiment of a machine tool according to the present disclosure. In particular, this exemplary embodiment of a machine tool can be used for carrying out a method according to the first aspect of the present disclosure.

The machine tool includes a workpiece holder 10 drivable about an axis of rotation C2 and a tool holder 20 drivable about an axis of rotation B1. The tool holder 20 is traversable relative to the workpiece holder 10 via a plurality of machine axes of the machine tool. The workpiece holder therefor is traversable via a plurality of machine axes of the machine tool, while the workpiece holder 10 is arranged on the machine bed 50 via the axis of rotation C2. In alternative embodiments of the present disclosure, however, the tool holder 20 might also be traversable via machine axes, or both the workpiece holder and the tool holder might be traversable via machine axes.

In the exemplary embodiment shown in FIG. 1, the tool holder 20 is linearly traversable in a first direction via a first linear axis Y1. The linear axis Y1 is designed as a carriage guide 30 via which the tool holder 20 is linearly traversable by means of a carriage. In the exemplary embodiment, the linear axis Y1 is aligned perpendicularly to the axis of rotation B1 of the tool holder 20 and perpendicularly to the axis of rotation C2 of the workpiece holder 10.

The tool holder 20 furthermore is traversable via a second linear axis X1 in a second direction parallel to the axis of rotation B1 and/or perpendicularly to the axis of rotation C2 of the workpiece holder 10 and/or perpendicularly to the linear axis Y1. Furthermore, the tool holder 20 is traversable via a third linear axis Z1 in a third direction parallel to the axis of rotation C2 of the workpiece holder 10.

In the exemplary embodiment this is effected in that the linear axis Y1 is arranged on a tool stand 40 by means of the linear axis Z1, wherein the tool stand 40 is traversable relative to the machine table 50 via the linear axis X1.

Other kinematic and constructional configurations of the machine tool can likewise be used for realizing the present disclosure. Possibly, however, the axis of rotation B1 of the tool holder 20 extends perpendicularly to the axis of rotation C2 of the workpiece holder, i.e. in a plane that is perpendicular to the axis of rotation C2 of the workpiece holder. Possibly, the axis of rotation B1 is perpendicular to the first linear axis. However, this is not absolutely necessary for carrying out the present disclosure.

The machine tool includes a merely schematically illustrated control unit 60 for actuating the axes of rotation and the machine axes. The machine axes and the axis of rotation of the workpiece holder possibly are NC axes. The control unit according to the present disclosure possibly is programmed such that one of the methods of the present disclosure described in the following can be carried out on the machine tool, and in particular is carried out automatically by the control unit of the machine tool.

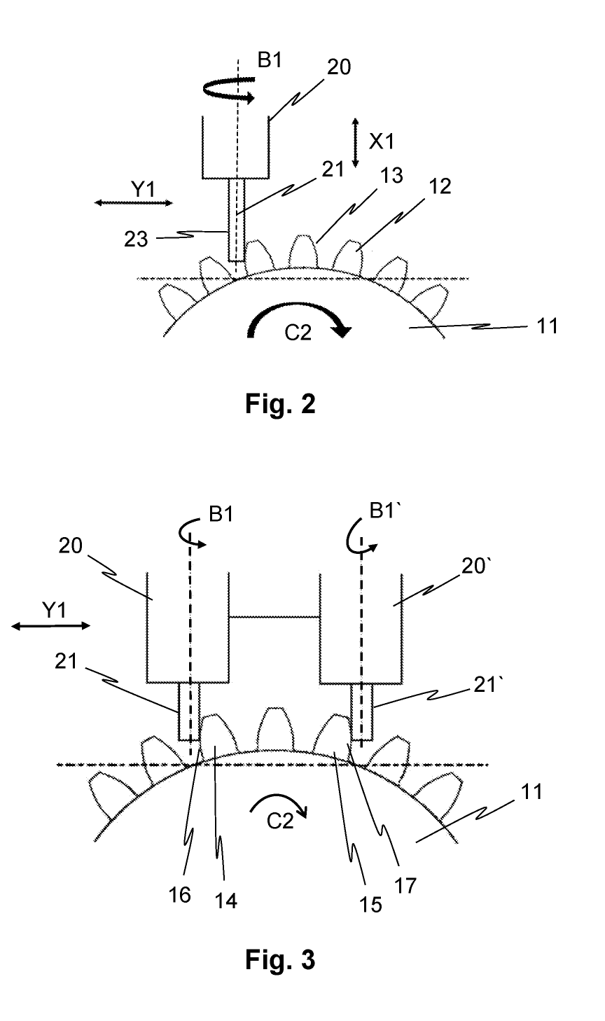

FIG. 2 shows an exemplary embodiment of a method for gear cutting according to the first aspect of the present disclosure. For this purpose a tool 21 with a circular cylindrical shell surface 23 is used, which is arranged in the tool holder 20 and is drivable about the axis of rotation B1. Due to the rotation of the tool about its axis of rotation B1 a chip-removing machining of the workpiece is effected when the shell surface 23 of the tool 21 comes into engagement with the workpiece.

For machining the tooth flanks 13 of the teeth 12 of the workpiece 11 the tool with its shell surface 23 is guided along the tooth flank 13 of the workpiece 11 tangentially to the target contour to be produced.

According to an embodiment of the present disclosure, the tangential alignment of the shell surface 23 with respect to the target contour to be produced is effected by positioning the tool along a first linear axis and by the rotary position of the workpiece about its axis of rotation so that the alignment of the tool relative to the target contour is effected by linearly traversing the tool along the first linear axis Y1 and by a rotary movement of the workpiece about its axis of rotation. The workpiece 11 therefor is accommodated in the tool holder 10 and can be rotated about the axis of rotation C2.

A tangential alignment of the shell surface of the tool refers to the fact that the part of the shell surface which is in engagement with the tooth is aligned tangentially to the target contour to be produced. In particular, this can be effected in that the axis of rotation B1 is aligned parallel to a tangent at the target contour in the region of engagement with the toothing.

According to an embodiment of the present disclosure, pivoting of the tool holder 20 thereby can be omitted, as the alignment between the tool and the tooth flank exclusively is effected via a corresponding traversing movement along the first linear axis Y1 and a rotary movement of the workpiece 11 about the axis of rotation C2.

To produce an involute, the traversing movement of the tool holder 20 along the first linear axis Y1 possibly corresponds to the roll-out of the base circle of the toothing during the corresponding rotary movement of the workpiece 11 about its axis of rotation C2. In particular, the traversing path along the first linear axis Y1 proceeding from a position in which an extension of the shell surface of the tool 21 in contact with the toothing would intersect the axis of rotation C2 of the workpiece, can correspond to the roll-out of the base circle of the toothing during a rotary movement out of this position.

When the tooth flank reaches up to its base circle, the tool for machining the tooth flank on the base circle possibly is positioned such that the axis of rotation B1 of the tool holder 20 is away from a plane that extends radially to the axis of rotation C2 of the workpiece 11 by half the radius of the shell surface and is aligned parallel to the axis of rotation B1 of the tool holder 10. In this position, an extension of the tooth flank in engagement with the tooth intersects the axis of rotation C2.

The machining of a tooth flank possibly is effected in a plurality of machining strokes. This is advantageous in particular when a finish gear cutting method is used.

Finishing involves a removal of small amounts of material for fine machining. In a previously roughed workpiece, only some tenths of a millimeter mostly are removed. Finishing after roughing has the objective to achieve the required surface quality as well as dimensional accuracy and accuracy of shape. Depending on the required accuracy of the workpiece reference also is made to fine or extremely fine finishing. The objective here is to generate a good surface quality of the tooth flank.

To achieve a good surface quality of the tooth flank, the same is approached to the target geometry by tangents, which each are produced by a machining stroke.

In each individual of the machining strokes the tool holder 20 is in a particular position along the first linear axis Y1, and the workpiece 11 is in a particular rotary position by which the tangential alignment of the shell surface with the target contour is achieved. For carrying out the machining stroke, the tool 21 then is traversed along the tooth width in a direction parallel to the axis of rotation C2 of the workpiece 11. When it is a helical toothing, this movement is superimposed with a corresponding rotary movement of the workpiece about its axis of rotation C2.

After carrying out such a machining stroke, the relative position between the tool and the tooth flank to be produced is changed, so that the tool comes into engagement with the tooth in another position relative to the height direction of the toothing. For this purpose the relative alignment is also changed, as due to the curvature of the tooth flank and the tangential alignment of the shell surface with the target contour another alignment of the tool relative to the workpiece is used. According to an embodiment of the present disclosure, this is effected by a corresponding traversing movement of the tool in a first direction Y1 and a corresponding rotary movement of the workpiece 11 about its axis of rotation C2.

When in FIG. 2 the workpiece for example is rotated in anti-clockwise direction, the tool holder 20 is traversed to the left along the first linear axis Y1 by a corresponding distance that possibly corresponds to the roll-out of the base circle of the toothing. The tool thereby comes into engagement with the tooth flank at a higher position. Due to this coupled traversing and rotary movement, the shell surface of the tool, which is in engagement with the tooth, follows an involute. When profile modifications are to be produced, the ratio between traversing movement in the first direction and rotary movement can be modified correspondingly. In particular, such modifications can be the generation of a profile crowning and/or a tip and/or root relief. Depending on the desired accuracy in the generation of the tooth profile a corresponding number of machining strokes are used, which each approach the target contour via corresponding tangent pieces.

In the context of the present disclosure, the tool holder 20 can also be traversed parallel to its axis of rotation B1 along the second linear axis X1. In particular, this can be used to bring a certain part of the shell surface of the tool into engagement with the tooth. In this way, for example the wear can be distributed along the extension of the tool and/or it can be ensured that the tool comes or remains in engagement with the toothing with its shell surface. Therefore, a traversing movement in the second direction X1 possibly can be effected together with a traversing movement in the first direction Y1. The magnitude of this traversing movement, however, is irrelevant for the contour produced as long as the shell surface actually is in contact with the toothing.

This represents the great advantage of the method of the present disclosure, as thermal expansions of the machine that take place parallel to the axis of rotation B1 of the tool holder 20 thereby have no influence on the toothing quality and the contour produced.

As for example in machine tools as they are shown in FIG. 1 the thermal expansion of the machine bed 50 chiefly has an influence on the relative position between tool holder 20 and workpiece holder 10 in the X1 direction, this influencing factor is eliminated completely in the method of the present disclosure according to the first aspect.

When only one tool holder 20 is provided, the same can be used both for machining left flanks and for machining right flanks. In the exemplary embodiment shown in FIG. 2, the gear cutting operation in the illustrated situation is effected on a left tooth flank. For this purpose, in particular the traversing path along the first linear axis Y1 to the left of a central position is required.

For carrying out a gear cutting operation on the right flanks of the toothing the tool is brought out of engagement with the left flank and into engagement with the right flank by a corresponding traversing movement along the first linear axis to the right. Furthermore, a rotary movement of the workpiece 11 is effected in clockwise direction in order to align the tool tangentially to the target contour.

On the right flank the same method is carried out as it has already been described above for the left flank, wherein merely the traversing movement to the right and the rotary movement in clockwise direction are effected in order to traverse the tool from an engagement position located further down on the tooth flank in the height direction to an engagement position located further up on the tooth flank in the height direction. For this purpose, chiefly the region in the first direction Y1 to the right of the central position is required.

The sequence in which the individual machining strokes are carried out on the two flanks and/or in the height direction on one flank can be chosen freely according to an embodiment of the present disclosure and in particular is not limited to the fact that strokes are carried out one after the other at successive height positions. Rather, what is also conceivable are machining strategies in which first a lower, then an upper and then a middle path are traversed. Furthermore, a machining operation possibly can also jump between the left and the right flank.

FIG. 3 shows a second exemplary embodiment of a method of the present disclosure according to the first aspect, in which two tool holders 20 and 20′ are used, which each are drivable about an axis of rotation B1 and B1′, respectively. Correspondingly, two tools 21 and 21′ are used.

The machining of the workpiece by means of the two tools 21 and 21′ each is effected such as has already been described above with regard to the exemplary embodiment in FIG. 2.

In the exemplary embodiment, the two tools 21 and 21′ are used to at the same time machine a left flank 16 of a first tooth 14 and a right flank 17 that possibly is arranged on a second tooth 15.

When machining is effected in a plurality of machining strokes, the two tool holders 20 and 20′ are traversed between two machining strokes by the same distance along the first linear axis Y1. This is due to the fact that the rotary movement about the axis of rotation C2 of the workpiece of course is identical for both tooth flanks 16 and 17. Therefore, when both tool holders are traversed according to the corresponding roll-out of the base circle of the toothing, an identical traversing movement is obtained for both of them. When modifications are produced, the distance of the two workpiece holders can also vary, however.

The individual machining strokes are oppositely shifted in the height direction on the two tooth flanks 16 and 17, i.e when on the first tooth flank 16 a first machining stroke is effected at a higher position and a second machining stroke is effected at a lower position, the corresponding first machining stroke on the tooth flank 17 is effected at a lower position and the second machining stroke is effected at a higher position.

The two tool holders 20 and 20′ are aligned parallel to each other for the machining operation. This can be specified either by the constructional configuration of the machine, or in the presence of corresponding pivot axes by a correspondingly identical alignment of these pivot axes.

To be able to use the machine tool for machining different gear wheels or to be able to produce modifications, the two tool holders 20 and 20′ should be separately traversable in the first direction Y1 so that the distance between the two axes of rotation B1 and B1′ is adjustable.

The two machining heads, however, can be arranged on the same linear guide and/or be traversable via common further axes.

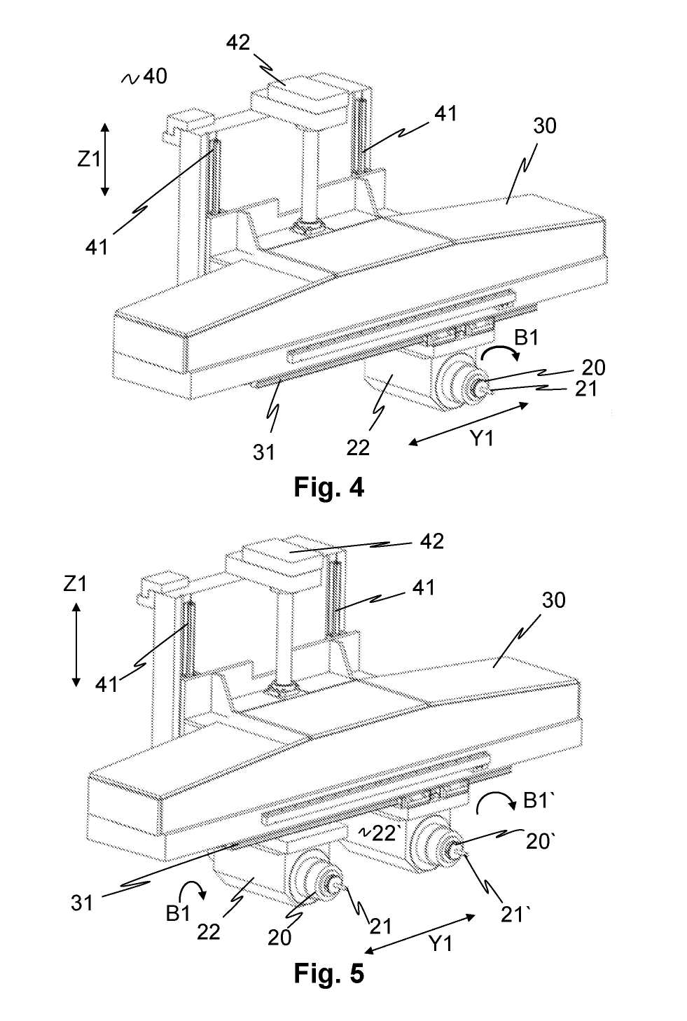

Concrete exemplary embodiments of machining heads, by which the exemplary embodiments according to FIG. 2 and FIG. 3 can be carried out, are shown in FIGS. 4 and 5.

FIG. 4 shows an embodiment with only one tool holder 20. The same is traversable together with its drive 22 along a linear guide 31 of the first linear axis Y1. The linear guide 31 is arranged on a carrier 30 that in turn is traversable along a linear guide 41 of the third linear axis Z1 parallel to the axis of rotation C2 of the non-illustrated workpiece holder 10. For this purpose, a drive 42 is provided. The linear guide 41 for example can be arranged on a tool stand 40, as it is shown in FIG. 1.

FIG. 5 shows an exemplary embodiment in which two tool holders 20 and 20′ are provided. The exemplary embodiment shown in FIG. 5 differs from the exemplary embodiment shown in FIG. 4 by the fact that along the linear guide 31 not only one tool holder, but the two tool holders 20 and 20′ are separately traversable in the first direction Y1. The two tool holders 20 and 20′ are configured identically in the exemplary embodiment.

Both exemplary embodiments have in common that a pivotability of the tool holders 20 and 20′ has been omitted.

In alternative embodiments, however, pivotable tool holders can also be used, as they are employed for example in usual 5-axes machining centers. In this case, the corresponding pivot axis simply can be adjusted or fixed such that the kinematics and alignment described above are obtained.

In a second aspect, the present disclosure comprises a method for the rough gear cutting of a workpiece which can also be used independent of the first aspect. An exemplary embodiment of such a method is shown in FIG. 5.

The objective of a rough gear cutting operation involves approaching the workpiece to the final contour within a short machining time. Therefore, this usually is a rough milling operation by which a large amount of material is removed from the tooth gap. After carrying out the roughing method, the tooth flank surface is rough in the method according to conventional methods and machining marks are distinctly visible.

By the method according to the second aspect a smoother surface structure is achieved by roughing and/or the roughing process is accelerated.

In the exemplary embodiment shown in FIG. 5 for a method according to the second aspect tools 21 and 21′ with a circular cylindrical shell surface are used. In particular, these are end mills.

In a first machining step (a) a milling cutter 21 having a larger diameter is used to generate a radially aligned groove along the tooth gap. The first groove possibly has a depth of at least 0.3 times the tool diameter. In a second machining step (b) a tool 21′ of smaller diameter is used, which dips deeper into the tooth gap and likewise generates a radially aligned groove along the tooth gap. This second milling cutter 21′ then in two steps (c) and (d) is tilted relative to the alignment of the radial grooves in the direction of the left and right flank, so that the shell surface of the milling cutter, which is in engagement with the tooth flank, each is aligned tangentially to the target contour. For the tangential strokes, the inclination of the tool lies in the order of magnitude of the pressure angle of the toothing.

The tool therefore does not generate the width of the tooth gap in a plurality of lines set one beside the other, but by means of the first milling cutter 21 of larger diameter a first removal of material is realized over a large part of the width of the tooth gap so that subsequently the second milling cutter 21′ of smaller diameter can dip deeper into the tooth gap and a groove can also be generated there, which realizes a large part of the width of the tooth gap. After these rough material removals have been effected, a further approach to the desired final contour is realized by means of tilting the second milling cutter 21′ from the middle of the toothing in both directions each. Tilting also has the advantage that almost the entire length of the milling cutter comes into engagement with the material and thus the wear of the milling cutter is reduced.

The radial grooves, which are produced in steps (a) and (b), possibly each extend centrally with respect to the tooth gap, wherein at least the second milling cutter 21′ possibly produces the tooth base 19 with its head region when producing the groove.

As an alternative to the tool with a circular cylindrical shell surface as used in FIG. 5, a tool with a conically tapering shell surface also might be used by the same method. Here, merely the cone angle is taken into account when tilting the tool.

In a possible embodiment of the present method, the tangential machining of the tooth flanks can be effected in a single stroke. In particular in the case of large toothings, the deviations between a straight line and an involute are not particularly large so that with one stroke over the entire tooth height a sufficient approach to the target contour already is possible.

When the machining allowance is too large in one machining stroke, the tangential machining can also be effected in a plurality of tangential strokes offset from each other in the height direction.

With regard to the tangential alignment of the tool and the target contour it is to be taken into account that during rough gear cutting the target contour of course does not correspond to the final contour, but provides a certain machining allowance which then is removed in the subsequent finish gear cutting operation.

The method according to the second aspect of the present disclosure can be realized in that the alignment of the milling cutter or the tilting described above in detail is performed by pivoting of the tool holder. This is largely unproblematic because this anyway is only a rough machining operation, and therefore possible deviations from the desired contour due to a thermal expansion of the machine can be accepted.

Subsequent to such a roughing method the finish machining according to the first aspect of the present disclosure possibly can be effected in order to ensure a correspondingly high surface quality.

However, the rough gear cutting method according to the second aspect can be used with the kinematics according to the first aspect, i.e. instead of pivoting the tool holder, a linear traversing movement of the tool holder can be combined with a corresponding rotary movement of the workpiece in order to change the alignment of the tool relative to the toothing.

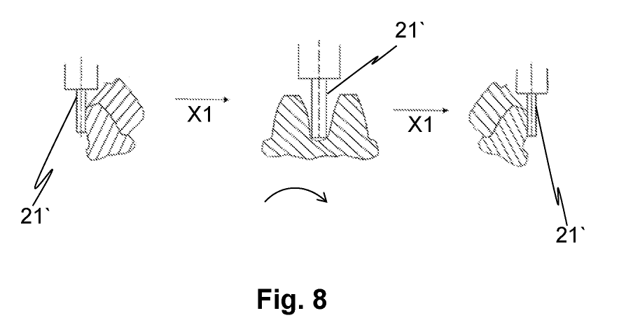

Such a procedure is shown in FIG. 8. According to the method shown in FIG. 8 no pivoting of the tool 21′ therefore is effected, but a traversal along the first linear axis X1 and a rotary movement of the workpiece.

The exemplary embodiment of the second aspect as shown in FIG. 8 can be carried out on a machine tool as it has been described above in detail with reference to FIGS. 1, 4 and 5. Furthermore, the method can be effected such as has already been described above with regard to the first aspect.

However, in the simplest exemplary embodiment merely a single tangential machining stroke is used here in order to machine the entire height of the tooth flank. However, when this is not sufficient for the rough gear cutting operation or the required approach to the target contour, the roughing method also can involve a plurality of machining strokes offset from each other in the height direction. This can in turn also be carried out according to the first aspect of the present application.

FIG. 8 on the left shows the tangential machining of a left tooth flank in one machining stroke, in the middle the radial position and on the right the tangential machining of a left tooth flank, wherein the radial or tangential alignment each is effected by traversing the milling cutter in the linear direction X1 and by a rotary movement of the workpiece about its axis of rotation.

The three machining strokes can, but need not necessarily be effected in the sequence in which first the radial groove and then the tangential machining operations are carried out. Rather, there can also be chosen another sequence, as this is shown in FIG. 8.

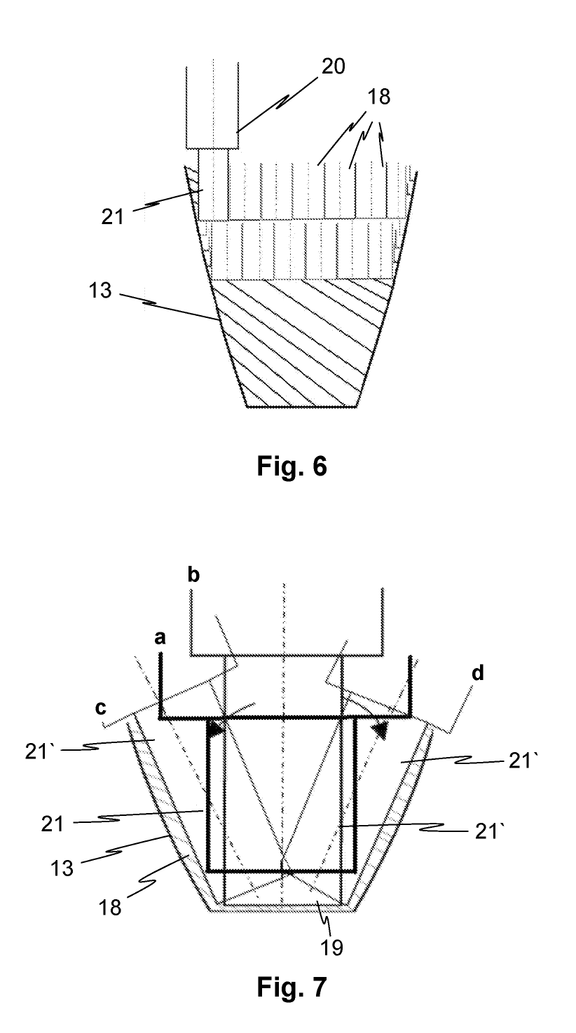

As an alternative to the procedure shown in FIG. 6, however, one might also start with the radial position shown in the middle of FIG. 6, and then the machining positions shown on the left and on the right can be reached by corresponding linear traversing movements of the tool and rotary movements of the workpiece.

The advantage of an embodiment of use of the first aspect also in connection with the second aspect in particular consists in that the rough gear cutting operation therefore neither requires a pivot axis for the tool holder. Therefore, the method can be carried out on the same machine tool as a method according to the first aspect used for the subsequent finish gear cutting operation, without an additional pivot axis being required.

In particular, this embodiment of the second aspect provides for carrying out both the rough gear cutting operation and the finish gear cutting operation on a 4-axes machining center.

1. A method for gear cutting a workpiece comprising:
using a machine tool that comprises a workpiece holder drivable about an axis of rotation and at least one tool holder drivable about an axis of rotation,
gear cutting the workpiece using a tool with a circular cylindrical shell surface,
guiding the shell surface along a tooth flank of the workpiece tangentially to the target contour to be produced, and
positioning the tool along a first linear axis and positioning the workpiece about its axis of rotation to produce the tangential alignment of the shell surface relative to the target contour.

2. The method according to claim 1, further comprising guiding at least one machining stroke the tool for machining a tooth flank of the workpiece along the tooth flank in the workpiece width direction, wherein the machining of the tooth profile is effected in a plurality of machining strokes offset from each other in the height direction of the tooth flank, wherein the offset of the machining strokes among each other is achieved by a correspondingly changed position of the tool along the first linear axis and a correspondingly changed angle of rotation of the workpiece about its axis of rotation.

3. The method according to claim 1, further comprising keeping the alignment of the tool unchanged during the gear cutting operation and/or for several machining strokes, and/or wherein during finishing and/or the final machining of the workpiece the tool always is aligned parallel to a second linear axis that extends radially to the workpiece center, and/or wherein the axis of rotation of the tool is perpendicular to the first linear axis and/or perpendicular to the axis of rotation of the workpiece and/or perpendicular to a third linear axis that extends parallel to the axis of rotation of the workpiece.

4. The method according to claim 1, further comprising producing the tooth flank of an involute toothing using a traversing movement of the tool along the first linear axis and a rotary movement of the workpiece about its axis of rotation are in a linear relationship to each other and/or wherein the traversing movement of the tool along the first linear axis corresponds to the roll-out of the base circle of the involute toothing.

5. The method according to claim 1, wherein a toothing with a toothing diameter greater than 500 mm and/or greater than modulus 8 is produced and/or machined.

6. The method according to claim 1, wherein the tool holder is traversable via a second linear axis perpendicular to the axis of rotation of the workpiece holder, wherein the first linear axis and the second linear axis are perpendicular to each other and/or wherein during the gear cutting operation the axis of rotation of the workpiece holder is aligned parallel to the second linear axis, and/or wherein the tool holder is traversable via a third linear axis parallel to the axis of rotation of the workpiece holder, wherein in at least one machining stroke in the workpiece width direction the tool is guided along the tooth flank via the third linear axis, wherein for generating a helical toothing the traversal of the tool along the third linear axis is superimposed with a rotary movement of the workpiece.

7. The method according to claim 1, further comprising machining a left tooth flank of the workpiece using a tool arranged along the first linear axis in a first area of linear positions, and machining a right tooth flank of the workpiece using a tool arranged along the first linear axis in a second area of linear positions, and
generating a symmetrical toothing using the first and the second area arranged symmetrically to a plane that extends radially to the axis of rotation of the workpiece and parallel to the axis of rotation of the tool, and/or wherein the first and the second area overlap by a maximum of 50% of their expansion and/or by a maximum of twice the radius of the cylindrical shell surface of the tool, and/or wherein at least the larger part each of the two areas is located on opposite sides of a plane that extends radially to the axis of rotation of the workpiece and parallel to the axis of rotation of the tool.

8. The method according to claim 1, further comprising using the same tool for machining of the left and of the right tooth flank of the workpiece.

9. The method according to claim 1, further comprising machining the left and the right tooth flank of the workpiece using two tools, which each are accommodated in a tool holder,
wherein the axes of rotation of the two tool holders are arranged parallel to each other and/or wherein the machining of a left and a right tooth flank is effected at the same time, wherein a plurality of machining strokes offset in the height direction of the respective tooth flank are used, wherein successive machining strokes on the respective tooth flanks in the height direction are offset from each other in the reverse direction and/or between two machining strokes the two tools are traversed along the first linear axis (Y1) in the same direction and/or by the same distance.

10. A method for rough gear cutting a workpiece on a gear cutting machine that comprises a workpiece holder drivable about an axis of rotation and a tool holder drivable about an axis of rotation, comprising the steps of:
gear cutting of a workpiece using a tool with a circular cylindrical or conical shell surface,
producing a tooth pitch by producing, in at least one first machining stroke, a groove which is aligned radially, and
aligning in at least two more machining strokes the shell surface of the tool substantially tangentially to the target contour of the left and the right flank of the toothing forming the tooth gap.

11. The method according to claim 10, wherein one after the other two or more differently sized tools are used in order to produce a first radial groove of larger width and in this groove at least one further radial groove of smaller width, wherein the smallest tool is used for producing the tooth base and/or wherein the smallest tool is used for the two more machining strokes with a shell surface aligned tangentially to the target contour.

12. A gear cutting machine comprising:
a workpiece holder drivable about an axis of rotation and at least one tool holder drivable about an axis of rotation;
a gear cutting operation a tool with a circular cylindrical shell surface,
a control unit including a controller, memory and programs for automatically carrying out the following:
guiding the shell surface along a tooth flank of the workpiece tangentially to the target contour to be produced, and
positioning the tool along a first linear axis and positioning the workpiece about its axis of rotation to produce the tangential alignment of the shell surface relative to the target contour.

13. The gear cutting machine according to claim 12, wherein the tool holder is non-rotatably arranged on the gear cutting machine and is traversable only via one or more linear axes, wherein three linear axes perpendicular to each other are provided,
and/or wherein the tool holder is arranged on a machining head that is disposed opposite the workpiece holder in a second direction, which is perpendicular to the first linear axis and/or extends parallel to the axis of rotation of the tool holder, wherein the machining head is arranged on a machine table via a machine stand, which carries the workpiece holder, wherein the machine table extends in the second direction between the workpiece holder and the machining head.

14. The gear cutting machine according to any of claim 12, wherein the gear cutting machine includes a tool holder that is traversable from a first side of a plane that extends radially to the axis of rotation of the workpiece holder and is aligned parallel to the axis of rotation of the tool holder and/or perpendicularly to the first linear axis to the opposite side, and/or wherein the traversing path provided by the first linear axis is symmetrical to a plane that extends radially to the axis of rotation of the workpiece holder and is aligned parallel to the axis of rotation of the tool holder and/or perpendicularly to the first linear axis.

15. The gear cutting machine according to claim 12, comprising at least two tool holders each drivable about an axis of rotation, which are separately traversable along at least one linear axis, wherein the two tool holders are traversable on a common guide of the first linear axis of the gear cutting machine and/or are jointly traversable via one or more further linear axes.

16. The method of claim 10, wherein the groove produced in the first machining stroke has a depth of at least 0.3 times the tool diameter and wherein an inclination of the shell surface of the tool lies in an order of magnitude of the pressure angle of the toothing in the at least two more machining strokes.
